(19) United States
(12) Patent Application Publication
(10) Pub. No.: US 2012/0216442 A1
(43) Pub. Date: Aug. 30, 2012

(54) BAIT HOLDER FOR FISHING HOOK

(76) Inventor: James MERRITT, Whiteville, NC (US)

(21) Appl. No.: 13/403,055

(22) Filed: Feb. 23, 2012

Related U.S. Application Data
(60) Provisional application No. 61/446,422, filed on Feb. 24, 2011.

(51) Int. Cl. A01K 85/02

(52) U.S. Cl. 43/42.1

(57) ABSTRACT

A bait holder adapted for securing a fishing hook to a soft plastic bait while fishing a “weedless” technique during bass fishing. The bait holder includes an attachment portion, adapted to be inserted through the eye of the fishing hook for securely attaching to the fishing hook. The bait holder further includes a first hook extending from the attachment portion and being adapted to be inserted through a portion of a soft bait for securing the soft bait to the first end of the fishing hook during use. The bait holder of the present invention allows the fisherman to pull his bait through the thickest of vegetation without the top of the plastic bait sliding down the shaft of the hook.

### CROSS REFERENCE TO RELATED APPLICATION

This application claims the benefit of U.S. Provisional Application No. 61/446,422, filed Feb. 24, 2011, which is hereby incorporated by reference.

### FIELD OF THE INVENTION

The present invention relates to a bait holder for fishing hook.

### BACKGROUND OF THE INVENTION

While fishing through weeds and other obstacles, plastic baits have a tendency to slide down the shaft of the hook. The present invention provides a solution to this problem.

### SUMMARY OF THE DISCLOSURE

According to the principles of the present invention, a bait holder for a fishing hook is provided. The bait holder can be used with a fishing hook having an eye at a first end, a sharp tip at a second end, and a curved shaft connecting the first end with the second end. The bait holder includes an attachment portion, adapted to be inserted through the eye of the fishing hook for securely attaching to the fishing hook. The bait holder further includes a first hook extending from the attachment portion and being adapted to be inserted through a portion of a soft bait for securing the soft bait to the first end of the fishing hook during use.

### BRIEF DESCRIPTION OF THE DRAWINGS

FIG. 1 is a top view of the first embodiment of the invention, showing a bait holder formed in the shape of a question mark attached to the eye of the hook.

FIG. 2 is a top view of the bait holder of FIG. 1 after it has been attached to a head of a soft plastic bait.

FIG. 3 is a top view of the bait holder of FIG. 1 after the sharp tip of the fishing hook has been attached to the body of the soft plastic bait.

FIG. 4 is a top view of the second embodiment of the invention, showing a bait holder formed having a W-shape placed next to a dime.

FIG. 5 is a top view of the bait holder of FIG. 4, after it has been attached to the eye of the fishing hook.

FIG. 6 is a top view of the bait holder of FIG. 4 according to a first method of use, after it has been attached to a head of a soft plastic bait and after the sharp tip of the fishing hook has been attached to the body of the soft plastic bait.

FIG. 7 is a top view of the bait holder of FIG. 4 according to a second method of use, after it has been attached to a head of a soft plastic bait and after the sharp tip of the fishing hook has been attached to the body of the soft plastic bait

### DETAILED DESCRIPTION OF THE INVENTION

The drawings show bait holder adapted for securing a fishing hook to a soft plastic bait while fishing a “weedless” technique during bass fishing. The bait holder of the present invention allows the fisherman to pull his bait through the thickest of vegetation without the top of the plastic bait sliding down the shaft of the fishing hook.

### First Embodiment

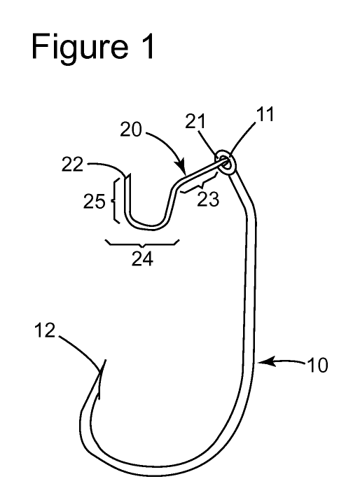

FIGS. 1-3 illustrate a first embodiment of the present invention.

FIG. 1 shows a fishing hook 10 having an eye 11 at a first end, a sharp tip 12 at a second end, and a curved shaft connecting the first end with the second end. A bait holder 20 has a first end with an attachment portion 21 formed as a loop and a first hook 24 extending from the attachment portion 21 which ends in a sharp tip 22. The attachment portion 21 of the bait holder is attached to the eye 11 of the fishing hook by being inserted thereto. In one embodiment, the bait holder 20 is attached to the fishing hook 10 before the assembly is sold to the end-user. In another embodiment, the bait holder 20 is sold separately from the fishing hook 10 and is attached by the end-user.

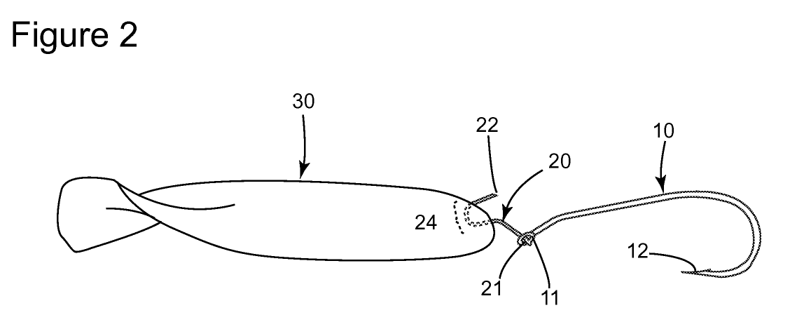

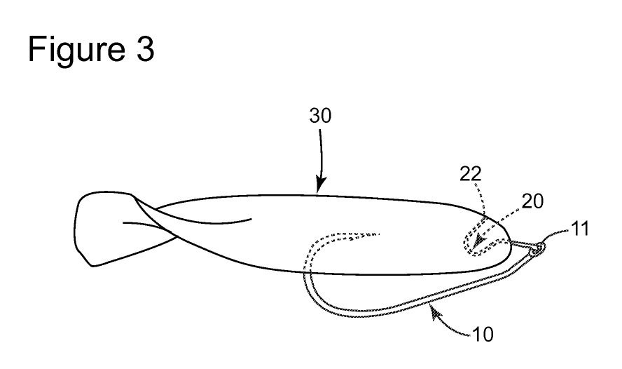

In the bait holder 20 illustrated by FIG. 1, a first shaft 23 extends from the attachment portion 21. A U-shaped hook 24 extends from the first shaft 23 and is adapted to be inserted through a portion of a soft bait (see FIGS. 2-3) for securing the soft bait to the first end 11 of the fishing hook during use. The U-shaped hook 24 includes a distal shaft 25 having an angle of 90 degrees or less relative to the first shaft 23.

The attachment portion 21 of the bait holder 20 is formed as a loop that lies in a first plane. The first hook 24 lies in a second plane orthogonal to the first plane. Unlike most “off-the-shelf” fishing hooks known in the art, both the eye 11 and curved shaft of the fishing hook 10 lie in the same plane.

During manufacturing the bait holder can be formed into any predetermined shape. In the illustrated embodiment, the bait holder 20 is formed as a single piece of wire which is formed into the shape of a question mark. The bait holder 20 can include any predetermined shape having at least one rounded corner, at least one square corner, or a combination of at least one rounded corner and at least one square corner. In another embodiment, the bait holder can be J-shaped.

The bait holder 20 can be formed into any three dimensional shape. However, in the illustrated embodiment, the first hook 24 lies in a single plane and the attachment portion 21 lies in a plane orthogonal to the single plane.

FIGS. 2-3 show the method of attaching the assembly of FIG. 1 to a soft plastic bait 30. The soft plastic bait 30 can be any shape and size. Referring to FIG. 2, the user can attach the first hook 24 of the bait holder 20 to a head of the soft plastic bait 30 by piercing the bait with the sharp tip 22. Referring to FIG. 3, next the user can insert the sharp tip of the fishing hook 10 into the body of the soft plastic bait 30 to fish a “weedless” technique.

### Second Embodiment

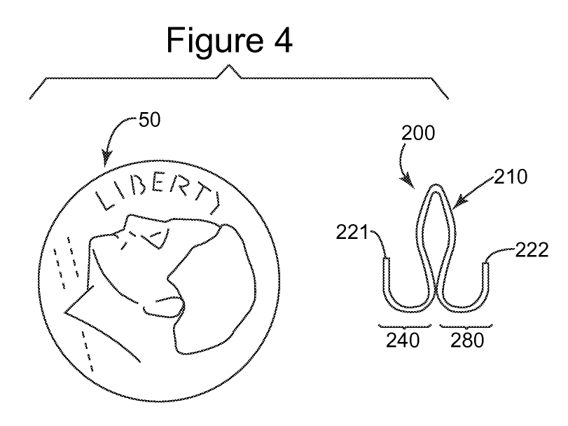

FIGS. 4-7 illustrate a second embodiment of the present invention.

FIG. 4 shows the bait holder 200 of the second embodiment placed next to a dime 50 to show scale. The bait holder 200 can be formed by bending a wire into a predetermined shape. The material of the wire can be a memory-shape material. The bait holder includes an attachment portion 210 that is generally diamond-shaped. The attachment portion 210 is preferably positioned near a mid portion of the bait holder 200 during use. A first hook 240 and a second hook 280 extend from the attachment portion 210, respectively. In the illustrated embodiment, the first hook 240 is symmetrically arranged with the second hook 280. The wire forming the bait holder 200 can include two ends that have a sharp tip 221, 222.

The bait holder 200 can include any predetermined shape having at least one rounded corner, at least one square corner, or a combination of at least one rounded corner and at least one square corner. The bait holder 200 shown in FIG. 4 can be considered to generally be W-shaped, wherein portions of the lower apexes of the W shape are closely spaced to each other to form a substantially closed loop. The height of each of the first and second hooks 240, 280 of the bait holder 200 is shorter than the total height of the bait holder.

The bait holder 200 can include any predetermined shape having at least one rounded corner, at least one square corner, or a combination of at least one rounded corner and at least one square corner.

The bait holder 200 can be formed into any three dimensional shape. However, in the illustrated embodiment, the bait holder lies in a single plane.

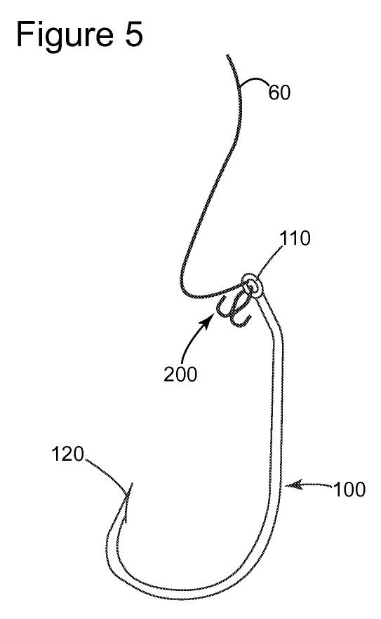

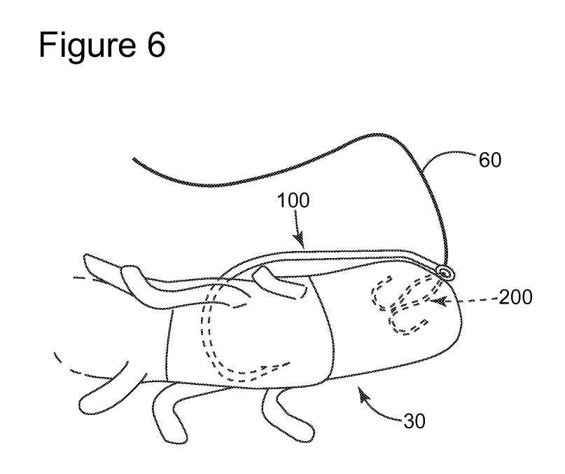

FIGS. 5-6 show a method of attaching the bait holder 200 a soft plastic bait 300. FIG. 5 shows a fishing hook 100 having an eye 110 at a first end, a sharp tip 120 at a second end, and a curved shaft connecting the first end with the second end. The bait holder 200 is attached to the eye 110 of the fishing hook by inserting one end of the wire. In one embodiment, the bait holder 200 is attached to the fishing hook 100 before the assembly is sold to the end-user. In another embodiment, the bait holder 200 is sold separately from the fishing hook 100 and is attached by the end-user. The fishing line 60 is shown in FIG. 5 being attached to the eye 110 of the fishing hook. The soft plastic bait 30 can be any shape and size. Referring to FIG. 6, the user can attach the bait holder 200 to a head of the soft plastic bait 30 by piercing the bait with one of the sharp ends. Next, the user can insert the sharp tip of the fishing hook 100 into the body of the soft plastic bait 30 to fish a “weedless” technique.

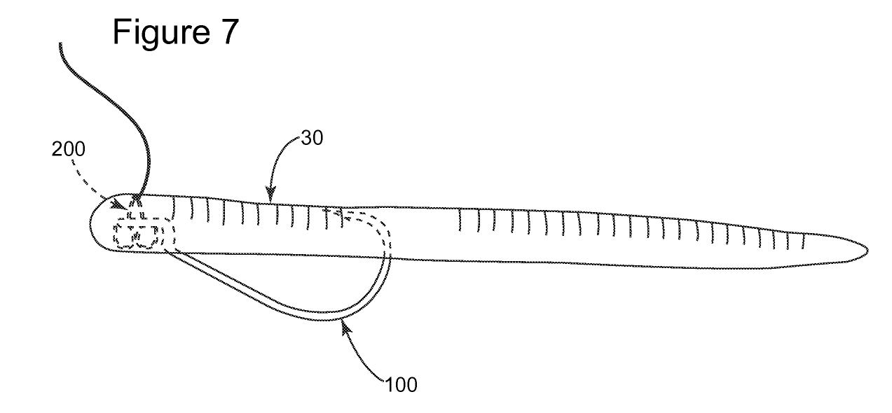

FIG. 7 shows another method of attaching the bait holder 200 to the fishing hook 100. The diamond-shaped attachment portion 210 is adapted to be compressed to be inserted through the eye of the fishing hook.

### CONCLUSION

It will thus be seen from the preceding that the problem set forth above is solved in a particularly effective, simple, and inexpensive way, with a considerable advantage to the user.

It is to be understood that although the invention as presented can be used with any type of hook, any type of bait, and any type of fishing. The invention can be used to fish over any kind of structure, through weeds and grass, and at any depth you want, including fresh water and sea water.

The above disclosure is intended to be illustrative and not exhaustive. This description will suggest many modifications, variations, and alternatives may be made by ordinary skill in this art without departing from the scope of the invention. Those familiar with the art may recognize other equivalents to the specific embodiments described herein. Accordingly, the scope of the invention is not limited to the foregoing specification.

What is claimed is:

1. A bait holder for a fishing hook having an eye at a first end, a sharp tip at a second end, and a curved shaft connecting the first end with the second end, the bait holder comprising:
an attachment portion, adapted to be inserted through the eye of the fishing hook for securely attaching to the fishing hook; and
a first hook extending from the attachment portion and being adapted to be inserted through a portion of a soft bait for securing the soft bait to the first end of the fishing hook during use.

2. The bait holder of claim 1, wherein:
the attachment portion lies in a first plane;
the first hook lies in a second plane orthogonal to the first plane;
both the eye and curved shaft of the fishing hook lie in the same plane.

3. The bait holder of claim 1, wherein the attachment portion is diamond-shaped, further comprising a second hook extending from the attachment portion symmetrically to the first hook.

4. The bait holder of claim 1, wherein:
the attachment portion is diamond-shaped and is adapted to be compressed to be inserted through the eye of the fishing hook.

5. The bait holder of claim 1, wherein the bait holder is formed of a single piece of wire which is formed into the shape of a question mark.

6. The bait holder of claim 1, wherein the bait holder is formed of a single piece of wire which is formed into a predetermined shape having at least one rounded corner.

7. The bait holder of claim 1, wherein the bait holder is formed of a single piece of wire which is formed into a predetermined shape having at least one square corner.

8. The bait holder of claim 1, wherein the bait holder is formed of a single piece of wire which is formed into a predetermined shape having at least one rounded corner and at least one square corner.

9. The bait holder of claim 1, wherein the bait holder is J-shaped.

10. The bait holder of claim 1, wherein the first hook lies in a single plane and wherein the attachment portion lies in a plane orthogonal to the single plane.

11. The bait holder of claim 1, wherein the bait holder is W-shaped.

12. The bait holder of claim 11, wherein the bait holder lies in a single plane.

13. The bait holder of claim 1, further comprising a second hook extending from the attachment portion.

14. The bait holder of claim 13, wherein the second hook is symmetrically arranged with the first hook, and the first and second hooks lie in the same plane.

15. The bait holder of claim 11, wherein portions of the lower apexes of the W shape are closely spaced to each other to form a substantially closed loop.

16. The bait holder of claim 11, wherein the attachment portion is positioned near a mid portion of the bait holder.

17. The bait holder of claim 11, wherein the height of each of the first and second hooks of the bait holder is shorter than the total height of the bait holder.

18. The bait holder of claim 11, wherein the lower apexes of the W shape form rounded corners.

19. The bait holder of claim 11, wherein the lower apexes of the W shape form square corners.

20. A bait holder for a fishing hook having an eye at a first end, a sharp tip at a second end, and a curved shaft connecting the first end with the second end, the bait holder comprising:
an attachment portion, adapted to be inserted through the eye of the fishing hook for securely attaching to the fishing hook; and
a first shaft extending from the attachment portion;
a U-shaped hook extending from the first shaft and being adapted to be inserted through a portion of a soft bait for securing the soft bait to the first end of the fishing hook during use;
the U-shaped hook including a distal shaft having an angle of 90 degrees or less relative to the first shaft.
